(19) United States
(12) Patent Application Publication
(10) Pub. No.: US 2005/0286835 A1
(43) Pub. Date: Dec. 29, 2005

(54) Robust, self-aligning, low-cost connector for large core optical waveguides

(76) Inventor: Lonnie Curtis Maxey, Powell, TN (US)

Correspondence Address: UT-Battelle, LLC;Office of Intellectual Property, One Bethal Valley Road, 4500N, MS-6258, Oak Ridge, TN, 37831, US

(21) Appl. No.: 10/876,391

(22) Filed: Jun. 25, 2004

(51) Int. Cl. G02B 6/38

(52) U.S. Cl. 385/55; 385/53; 385/70; 385/75

(57) ABSTRACT

The optical waveguide connector comprises at least two optical waveguides abutting at a joint, the waveguides having a diameter variance in a predetermined range; a cover at least partially enclosing at least two optical waveguides, the cover having a first end, a second end, and an interior annular space; a collet proximate each first end and second end of the cover and removably coupled to an optical waveguide; and a sleeve removably abutting each collet and circumferentially surrounding the cover and each collet.

### STATEMENT REGARDING FEDERALLY SPONSORED RESEARCH

This invention was made with Government support under Contract No. DE-AC05-000R22725 awarded to UT-Battelle, LLC, by the U.S. Department of Energy. The Government has certain rights in this invention.

### TECHNICAL FIELD

The field of the invention is generally optical waveguide couplers, and specifically, couplers with connecting sleeves.

### DESCRIPTION OF THE BACKGROUND ART

From the optical fiber industry, it is well known that connection of one optical fiber, or waveguide, to another is non-trivial. The quality of the connection will affect the performance of the overall system. Furthermore, the effect is cumulative in large systems consisting of many interconnections, and signal losses at connector interfaces can become a significant factor in overall signal throughput. Many connector types and polishing methods have been developed to ensure reliable low-loss connections for the fiber optic waveguides used throughout the communications industry.

Large core optic waveguides are similar to the optical fibers used for communications but are much (up to two orders of magnitude) larger. These usually consist of a single plastic optical core surrounded by lower index material that serves as the waveguide cladding. Typically the cladding is then covered in another protective layer of material, referred to as the “jacket”. The size of the waveguides imparts physical characteristics to them that are very different than conventional optical fibers in terms of weight and flexibility. The materials used for large core optic waveguides are often different from those used in smaller optical fibers and the manufacturing tolerances are typically very loose in comparison with those associated with small fibers.

An effective means for coupling large core optical waveguides has not been standardized and there are few connectors available for them. No connectors have been observed that adequately address the special needs that arise when connecting large core optical waveguides.

U.S. Pat. No. 6,726,373 to Lutzen et al. teaches an optical fiber connector with an elastomeric cover that is not adaptable to different diameter fibers and provides no means for retaining index matching medium.

### SUMMARY OF THE INVENTION

An optical waveguide connector that is mechanically robust, resisting both tensile and bending stresses, and incorporates a means for maintaining axial alignment over the full variation in waveguide diameter allowances is described herein. The connector also incorporates a refractive index matching medium and a means for maintaining the medium in place between the waveguide ends.

The optical waveguide connector comprises at least two optical waveguides abutting at a joint, the waveguides having a diameter variance in a predetermined range; a cover at least partially enclosing at least two optical waveguides, the cover having a first end, a second end, and an interior annular space; a collet proximate each first end and second end of the cover and removably coupled to an optical waveguide; and a sleeve removably abutting each collet and circumferentially surrounding the cover and each collet.

### BRIEF DESCRIPTION OF THE DRAWINGS

FIG. 1 is a cutaway section of an embodiment of the optical waveguide connector.

### DETAILED DESCRIPTION OF THE PREFERRED EMBODIMENTS

Effectively coupling two large core optical waveguides requires that the unique characteristics associated with them be addressed. Among these, the weight and stiffness are the first and most obvious to consider. The weight of a segment of waveguide can be expected to produce significant tensile force on the connection and the coupler must be able to withstand this force without allowing the two waveguide ends to separate. The waveguides are often shipped and stored in large coiled lengths and may have an inherent curvature to them when they are installed. In addition, the waveguides may need to traverse several bends during installation. All of these conditions impose a requirement that the connector sleeve must have sufficient length and rigidity to oppose bending forces that would tend to flex the interface causing it to open.

Maintaining high efficiency in an optical waveguide connection requires that the two waveguides be well aligned to each other. That is to say that the central axis of one fiber be well-aligned to the central axis of the mating fiber. Failure to do so will allow the edges of the fibers to produce overlap zones which can allow leakage of the optical signal and consequent connection losses. An efficient connector design must incorporate means for maintaining the axial alignment of the two waveguide ends. This challenge is increased by the fact that the manufacturing tolerances for large core optical waveguides can be quite large. The optical waveguide diameter variance can be in the range of approximately 0% to 10%. This means that whatever means for maintaining axial alignment is incorporated, it must be applicable to the full range of variation in waveguide diameter, and must accommodate couplings scenarios in which a waveguide with minimum allowable diameter must be connected to maximum allowable diameter.

In any waveguide connection, there is a region between the two ends where the two cores do not perfectly contact each other. In most instances this produces an air gap (albeit very small) between the two waveguides. The difference in refractive index between the core material and air, causes reflections to occur at these gaps. At each connection about 8% of the transmitted light can be lost due to these unwanted air gaps. In systems employing many connections the cumulative losses can quickly become overwhelming. One solution that is used is to fill the gap with a material that has an index of refraction similar to that of the core material. In the optical fiber communication industry many materials can be used for this purpose. Because fiber diameters are so small and they are polished so flat (thus achieving very small air gaps between the ends), the surface tension of an index matching fluid is usually sufficient to hold it in place.

The use of index matching media with large core optical waveguides however is less simple. The surfaces of the waveguides are polished to a good mechanical flatness but may still have measurable surface contour. In addition, the diameter of the connection interface is rather large and the refractive index matching medium must remain in place over the entire surface. Index matching liquids that are commonly used for fibers in the communications industry would not readily remain in place over such large diameter interfaces with such large and varying gaps between them.

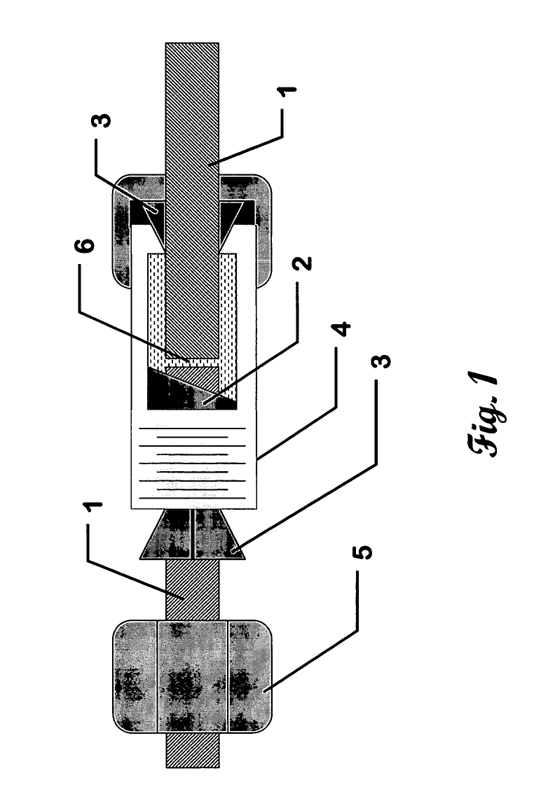

The central element of the robust, self-aligning, low-loss connector, as shown in FIG. 1, is an elastomeric cover 2, or bushing, that surrounds the two ends of the optical waveguides 1 that are being connected together. This cover 2 is slightly smaller in diameter than the waveguide material and must be stretched (slightly) over the ends of the waveguides 1. The resulting tensile forces balance themselves in such a way as to tend to bring the two waveguide ends into alignment with each other, ensuring an optimum connection. Additionally, heat and/or pressure can sufficiently applied to the connector causing the waveguides to fuse together.

A refractive index matching medium 6, or gel, is used in the connector to minimize reflective losses at the connection interface. Index matching gels have been very effective at filling the gap between the two waveguide ends and providing an un-interrupted interface across the full aperture of the large-core waveguides. The elastomeric cover 2 also serves as a reservoir for the index matching medium 6. The excess medium squeezes out into the bushing region surrounding the connection joint. This reservoir of gel is then available to flow back into the connection in the event that the joint is pulled open slightly by external forces.

To minimize the influence of bending stresses on the connection joint, the connector sleeve 4 is sized to be a mild interference fit over the elastomeric cover 2. In addition, the connector sleeve 4 extends for a length at least one waveguide diameter out in each direction away from the joint. This tends to support the waveguide sufficiently so as to avoid flexing the joint open in response to bending stresses.

The connection is held together by having the outside of the connector sleeve 4, or body, threaded to accept a compression nut 5. The compression nut 5 then squeezes down onto a compression collet 3, or ferrule, that is coupled onto the waveguide. The compression collet 3 is designed to grip the jacket of the waveguide 1 as it is tightened, forcing the waveguides into intimate contact as both compression nuts are tightened. Excellent results have been obtained using a modified version of a commercially available compression collet. The ferrule that is being used is manufactured by Swagelok® and is of a two-piece construction. For our 13.5 mm OD waveguide, a ½″ diameter nylon collet set is used. The collets are split down their sides to allow them to expand over the waveguide and also to permit them to be compressed so that they grip into the waveguide jacket.

Unique elements of the invention include elastomeric bushing creating tensile forces that ensure waveguide alignment; elastomeric bushing serving as reservoir for index matching medium; elastomeric bushing rigidly held (interference fit) inside of robust connector sleeve to provide rigid connection that is tolerant of variations in waveguide diameter.

Another embodiment of the robust connector uses index matching medium that is an adhesive. Yet another embodiment of the robust connector uses a collet that is crimped onto the waveguide as opposed to the compression collet. Yet another embodiment of the connector uses a push-nut or similar gripping device in place of the compression collet to exert compressive force onto the waveguide joint.

While there has been shown and described what are at present considered the preferred embodiments of the invention, it will be obvious to those skilled in the art that various changes and modifications can be made therein without departing from the scope.

1. An optical waveguide connector comprising:
at least two optical waveguides abutting at a joint, said waveguides having a diameter variance in a predetermined range;
a cover at least partially enclosing said at least two optical waveguides, said cover having a first end, a second end, and an interior annular space;
a collet proximate each of said first end and second end of said cover, said collet removably coupled to an optical waveguide; and
a sleeve removably abutting each collet and circumferentially surrounding said cover and each collet.

2. The connector of claim 1 wherein said optical waveguide diameter variance is in the range of approximately 0% to 10%.

3. The connector of claim 1 wherein said cover is an elastomeric material.

4. The connector of claim 1 wherein said sleeve extends away from said joint at least one waveguide diameter in both directions along the length of said waveguides.

5. The connector of claim 1 wherein said collet is selected from the group consisting of a compression collet, split compression collet, crimped collet, and push-nut.

6. The connector of claim 1 wherein said refractive index medium further comprises an adhesive.

7. The connector of claim 1 wherein heat is sufficiently applied to cause said waveguides to fuse together.

8. The connector of claim 1 wherein pressure is sufficiently applied to cause said waveguides to fuse together.

9. The connector of claim 1 wherein heat and pressure are sufficiently applied to cause said waveguides to fuse together.

10. The connector of claim 1 wherein said interior annular space is at least partially filled with refractive index matching medium.
